(19) United States
(12) Patent Application Publication
(10) Pub. No.: US 2002/0122363 A1
(43) Pub. Date: Sep. 5, 2002

(54) Compact disc comprising a section disturbing a copying process

(75) Inventor: Edward Skotnicki, Berlin (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: DOCdata Germany BMS Berlin Mastering Services GmbH, Berlin (DE)

(21) Appl. No.: 09/907,500

(22) Filed: Jul. 18, 2001

(30) Foreign Application Priority Data
Jul. 18, 2000 (DE) 10035311.8

(51) Int. Cl. G11B 7/24

(52) U.S. Cl. 369/47.12; 369/53.21; 369/275.3

(57) ABSTRACT

The invention relates to a compact disc comprising information sections in the sequence lead-in area, data block, lead-out area, said lead-in area comprising an organization information block with information about organization properties of the data block, and comprising a section disturbing a copying process. It is characterized in that the organization information block contains wrong organization information with regard to the immediately following data block and/or contains a non-evaluable blocking area and/or the compact disc contains a second organization information block with a non-evaluable blocking area behind the data block.

### Field of the invention

The invention relates to a compact disc comprising information sections in the sequence lead-in area, data block, lead-out area, said lead-in area comprising an organization information block with information about organization properties of the data block, and comprising a section disturbing a copying process.

Within the data block various types of information may be included. This can for instance be audio information according to the Red Book. Then it is a compact disc digital audio. However, there could also be involved software information for a computer according to the Yellow Book.

Then it is a CD-ROM or CD-ROM information, respectively. An extension of the latter standard is the CD-ROM/XA. CD-ROM information and audio information may commonly be provided on a compact disc. The invention is basically useful for all types of information in the data block, as long as a lead-in area is provided before the data block. Further, the invention can be used for multi-session compact discs. Such compact discs are called CD Extra and meet the standards of the Blue Book. For instance, an audio session having an own lead-in area and an own lead-out area as well as a CD-ROM/XA session having an own lead-in area and an own lead-out area may be provided on one single compact disc.

A compact disc can in principle be designed in any size and shape. Usually round compact discs having an outside diameter of 120 mm or 80 mm are employed. In shaped compact discs, the maximum dimensions in the radial direction from the central hole are not larger than 120 mm or 80 mm.

A compact disc contains physical structures disposed sequentially and being readable optically, starting at the section close to the central hole and spirally extending toward outside up to the end of the information.

The term compact disc further comprises DVD's (digital versatile disc) having a high storage capacity. Audio/video information is typically stored on a compact disc or a DVD in AC-3, dolby digital, dolby surround, DTS or MPEG2.

### BACKGROUND OF THE INVENTION

The fabrication of a compact disc is typically performed as follows. The information to be transferred to a compact disc is first stored on a data carrier. In a pre-mastering step, the data are processed, and files are formed therefrom. The files are then formatted and prepared for mastering. In the mastering step, first corrections and check sum data (EDC, ECC) are added. Further, the lead-in area and the lead-out area are generated, if necessary for each session separately, and added before or after the information (of each session, if multi-session is used). The lead-in area includes organization information with regard to the following information. This is on one hand information about the format of the information. Further, this may for instance include information about the length of individual tracks of the information, in the case of audio information for instance about the time duration of a piece of music. Finally, information about the individual tracks, for instance titles, may also be included. The lead-out area defines the end of the contents of the compact disc or of a session, resp. A compact disc is usually read out beginning from the center.

After having put together the stream of information in the above manner, said stream of information is written on a master. This usually is a highly polished glass master with an extremely high surface quality like an astronomical mirror. Other substrate materials are of course also possible, provided that the surface is sufficiently plane and comprises a sufficient surface quality. The surface of the master carries a light-sensitive layer, the photo resist, or a layer of evaporable plastic, the non-photo resist. The stream of information is then used for the modulation of a laser spirally scanning the master from the center to the outside, the laser being switched on and off corresponding to the digital states of the information. A modified pulse-duration modulation (EFM) is used for coding the digital information. In the case of the photo resist, the exposed sections are washed out in a chemical development bath. In the case of the non-photo resist, the exposed sections of the evaporable coating are evaporated by laser energy. The exposed sections form depressions, the so-called pits. The not exposed positions form the original surface of the coating, the land. In the case of the photo resist, the pit size or the physical pit structure, for instance the pit length (seen in the direction of the spiral), and/or the pit edge structure, are controlled by the development process and adjusted in conformation with the standards. In the case of the non-photo resist, this is achieved by controlling the irradiated energy of the laser. Then, a metal layer is applied on the written-on master, normally nickel, for instance by argon ion sputtering. Then, by a galvanic method, the metal layer is built up, until a separation of the metal layer and the master becomes possible. Thus, a metal negative image of the master is obtained. By means of this negative image, now the compact discs can be fabricated. This takes place in a pure injection molding process or in a combined molding/stamping process. In the first case, the liquid structure material of the compact disc, usually polycarbonate, is injected into a mold, with one main face thereof forming the metal negative image. After cooling-down, solidifying and separating the plastic material, a plastic disc with pits and lands is obtained as a positive image. In the molding/stamping process, a stamper is pressed on a molded disc. Then that side of the disc containing the information in the form of pits and lands is metallized by sputtering, the reflectivity required for reading-out with a laser, for instance of a play-back unit, being adjusted. As materials in most cases aluminum, gold, silver and copper are used. The layer thickness is in the order of 20 to 100 nm, in most cases 40 to 50 nm. Finally, the metallized side of the disc is painted and imprinted, if required.

Play-back or read-out of a compact disc is performed from the side directed away from the metal layer by means of a laser beam. Focusing of the laser or of the photocell collecting the reflected laser light is made on the section of the surface plane of the land. Damages of the compact disc surface or contaminations are thus ignored. Laser light reflected by the land generates a signal in the photocell, whilst light reflected by a pit will be so diffracted by the transparent plastic carrier material of the compact disc that it will not generate a signal in the photocell. The sequence of the photocell states “no signal” and “signal”, occurring by reading with the laser in the spiral direction, represents the digital information being evaluated by the further electronic circuitry and being processed, for instance converted to an audio signal. It should be noted that the photocell state “no signal” and the photocell state “signal” comprise admissible electrical value ranges with an intermediate forbidden range. To the forbidden range cannot be assigned a digital state by the following electronic circuitry, which leads to faulty functions of the electronic circuitry or to error messages, resp. It is essential, therefore, for the proper operation that the height of the pits, the edge shapes thereof and the reflectivity of pits and lands are adapted such that reading-out will not lead to a photocell state in the forbidden range. Another criterion is that the pit length is in a standardized admissible range. Finally, scanning of a pit/land sequence must permit the demodulation to a digital signal.

The physical properties of conventional compact discs are as follows. The diameter is 120 mm or 80 mm. The central hole has a diameter of 15 mm. The thickness is 1.2 mm. The tracking width is 0.7 μm (DVD) or 1.6 μm (CD). The minimum pit length is 0.4 to 0.44 μm (DVD) or 0.83 to 0.972 μm (CD). The numerical aperture is 0.6 (DVD) or 0.45 (CD). The wavelength of the laser is 635 to 650 nm (DVD) or 770 to 795 nm (CD). The capacity is 4.7 to 17.08 GByte (DVD) or 650 MByte (CD; Yellow Book, mode 1). In principle, however, any physical properties may be selected for the invention, provided that correspondingly tuned laser devices are used. The statements with regard to the forbidden range are in each case valid.

Prior Art and Technical Object the Invention is Based On

In the compact discs of the above design known from practical applications, the information on the compact disc can be read by so-called burners fitted with a suitable software, and can be transferred to one or more recordable compact discs (empty “blanks”). Recordable compact discs are for instance CD-R (compact disc recordable) or CD-RW (compact disc re-writable). In both cases the pits are not formed in a physical manner, but are simulated by means of organic dyes or phase-change substances, with the reflectivity properties being modulated.

The transfer of the contents of a bought CD to a recordable CD is annoying for copyright reasons, since thus unauthorized copies of works are produced in an illegal way.

Several approaches for establishing protection from copying are known in practical use. A protection from copying has the effect that a burner or the software thereof cannot produce a copy of a bought compact disc used as a model, or that the copied information is modified or distorted during copying. Details of the known protection systems from copying are not published. Practical experience shows, for the employed protection approaches from copying, either that the protection mechanism can easily be circumvented, for instance by adaptation of the software of a burner, or that the protection mechanism will lead to problems during the legal play-back of the bought compact disc on a conventional play-back unit, for instance causes faulty functions of the play-back unit.

Further is known a simple protection from copying, wherein the sold compact discs include in the organization information an information part identifying the compact disc as a copy. This will be identified by a simple 1-to-1 copying/burner software, and the copying process is refused, since the production of a copy of a copy is inadmissible and the burner software is suitably designed. This kind of protection from copying can however relatively easily circumvented by re-programming the burner software.

The invention has the technical object, therefore, to provide a protection from copying, which on one hand will prevent copying with a burner in a reliable manner, but on the other hand will secure a proper operation of the compact disc during the legal play-back with a conventional play-back device.

Fundamentals of the Invention

For the solution of the above technical object, the invention teaches that the organization information block contains wrong organization information with regard to the immediately following data block and/or contains a non-evaluable blocking area and/or the compact disc contains a second organization information block with a non-evaluable blocking area behind the data block. In a preferred manner, the wrong organization information is delay information with regard to the tracks in the data block. In addition hereto or independently herefrom, the wrong organization information may be format information. Format information may also be completely missing. The organization information block may also be truncated. A blocking area cannot be evaluated, if either unreasonable information for a reading system is included, or if no structures to be detected as information are present. Both above measures may also be provided commonly, for instance within a single organization information block or in different organization information blocks of a multi-session compact disc being for instance provided with an audio session at the beginning and a CD-ROM session at the end. If the data block contains audio information, the set-up of wrong organization information in the respective lead-in area is preferred. Within a lead-in area before a CD-ROM data block, the blocking area is preferred. Before the lead-out area of CD-DA, however behind the data block, a section may also be provided that mimics a CD-ROM session, in particular the lead-in area of a CD-ROM session, this section then comprising the blocking area. An organization information block may in particular be a lead-in area or a lead-out area.

The invention is based on the detection that for copying by means of a burner with a respective software on the one hand and for play-back of a compact disc for instance on an audio player on the other hand various analyzing procedures take place. An important difference is that for copying a burner or the software thereof is dependent on the information in the lead-in area and/or on the format analysis in the data block of the model compact disc and does not (in a complementing way) analyze the data block thereof, whereas for instance an audio player may also have access to secondary information, so to speak, for repair of missing or wrong information from the lead-in area from the data block. This is based on that a burner has to establish a linear data stream, beginning with the (first) lead-in area. In contrast thereto, for instance a simple audio-only player or a drive adjusted to such behavior can determine that the accessed section of a track is not a pause between two tracks (due to wrong organization information with regard to the position of the track or the delay of the track), search for the nearest pause and then start in the found pause. The burner however would for instance start reading in the middle of a track and copying, which for obvious reasons will disturb in the illegal copy thus produced or will shut-off with an error message. It is understood that the wrong organization information is selected such that compensation by conventional correction algorithms of the play-back units is possible, i.e. the deviations of the contents of the wrong organization information from the correct organization information have to be within the correction tolerance ranges of the play-back units.

In other words, the basic concept of the invention is that to selectively disturb the analyzing process of a burner or of the software thereof, this process being required for the production of the copy or for reading-out of the copied model, by falsification of information contents or non-evaluable design of the compact disc within standardized information structures, such that a termination of the analyzing process takes place or an unsatisfying copy is obtained, a player however playing the compact disc protected from copying with correction routines anyway present without any problem.

In this context, the invention teaches in particular a compact disc comprising information sections with a data block, in particular audio block and/or CD-ROM, and at least one lead-in area and/or one lead-out area, lead-in area and/or lead/out including a blocking area comprising read-incompatible physical structures.

Preferred Embodiments of the Invention

In the following, initially embodiments of the last variant of the invention will be explained in more detail.

The blocking area may be disposed in the lead-in area set up before an audio block. It is preferred that the blocking area is set up so as to begin 0.1 to 60 s, preferably 1 to 15 s, in particular 2 to 10 s, before the end of the lead-in area. The blocking area may extend forward into the first track of the audio block, and that by preferably 0.1 to 60 s, more preferably 1 to 15 s, in particular 2 to 10 s. Then it is recommended that the first track of the audio block is configured as a zero file and has a length of preferably 1 to 600 s, most preferably 1 to 60 s, in particular 10 to 30 s, measured from the end of the blocking area. Zero file means that (read-compatible) digital zeroes or digital information not operating as an audio file or not producing an audio signal are set up as readable data stream. It is the purpose of this variant that a player will identify and indicate the next track containing true audio data as track 1, although basically the zero file (with part of the blocking area) would qualify already as track 1. In a CD in the version CD Extra at least one blocking area may also be provided, for instance in the lead-in area of the ROM track, optionally the lead-out area having in addition another blocking area. This blocking area may extend forward into the ROM track.

In detail the read-incompatible structures of the blocking area in the lead-in area before the audio bock are produced by modulation of the data stream signal with 1 to 10,000 kHz, preferably 10 to 1,000 kHz, in particular 50 to 200 kHz, and/ or of the blocking area in the lead-in area before the ROM track by modulation of the data stream signal with 1 to 10,000 Hz, preferably 10 to 1,000 Hz, in particular 10 to 100 Hz. In the case of the high frequencies a square wave function with an on-off ratio 1:1 to 1:10 has proven useful. In the case of the low frequencies an on-off ratio of 10:1 to 1:10 has proven useful. The data stream signal may be an electronic signal or an optical signal, i.e. of the laser. A modulation of the electronic data stream signal may be performed as usual by a mixer introduced into a suitable signal line. A modulation of the optical data signal stream may take place by means of a chopper arranged in the light beam of the laser by means of which the master is fabricated. In the case of the modulation of the electronic data signal stream, the modulation may take place by means of any wave shapes, for instance square waves, sinusoidal functions or triangular functions. The modulation should be performed such that the obtained signal is switched on and off in the timing of the period of the selected wave shape. The modulation signal may for instance be produced by means of a function generator or a simple oscillator and controlled with regard to frequency and optionally on-off ratio. A chopper is for instance a rotating device with cutouts, through which the laser light beam can pass, whereas otherwise the light beam is cut off. In the simplest case this is a motor-driven perforated disc, with the perforations being arranged along a circle intersecting the laser light beam. The on-off ratio of the modulation is then defined by the ratio of the length of the cutouts along the circle to the length of the sections between two cutouts along the circle. The frequency may be controlled by the speed of the chopper.

For the first variant of the invention (the following however applies also to the second variant, and vice versa) it is preferred that the blocking area contains physical structures being read-incompatible, and data fragment structures. Suitably these are disposed behind an audio data block. This improvement of the invention benefits of the fact that a burner or the software thereof will, if for instance a format information is missing in the lead-in area, search for the format information in other sections, too, for instance behind the data block. The read-incompatible physical structures will then lead to a break-down of the burner software, and the intended copying process is terminated with an error message or another program interruption. Data fragment structures can be read, cannot be used however in an analysis by the burner soft-ware, or are inconsistent concerning the data contents. Physical structures are read-incompatible if they will lead, during reading-out by a laser, to a condition of the photocell in the forbidden range, or will not permit any reasonable demodulation during pulse width modulation. This can be achieved without any problems for mastering by suitable process control, for instance during development or writing. The only thing that needs be secured by the process control system is that physical structures not meeting the standards will be generated in the blocking area. This is not difficult for the man skilled in that art being very familiar with the selection and control of processes according to the standards. The read-incompatible physical structures can be selected from the group “non-standard pit height, non-standard reflectivity, non-standard track spacing, non-standard edge slope of the pit edges, pit-free track, track with continuous pit, and combinations of such physical structures”. A pit-free track is a land extending over for instance one or several spiral revolutions. Corresponding considerations apply to the continuous pit. This can be achieved, for instance, by a non-standard frequency of rotation during mastering or by a corresponding laser control. Faulty functions of a burner or of its software due to such physical structures cannot be compensated even by a time-consuming re-programming of the burner. Rather, usually also the hardware of the burner would have to be adapted, which is expensive and would normally not be done by “normal” persons making illegal copies.

If the blocking area has a structure corresponding to the organization information and/or CD-ROM data, this will in addition secure that during the search for organization information the burner or its software will access to the blocking area, since it will first detect this as proper, and will be guided by the read-incompatible physical structures during reading into a faulty function or an error message .

The invention also relates to a method for the fabrication of a compact disc according to the invention comprising the following steps: a) a data acquisition takes place, b) the acquired data are formatted in a data block, c) an organization information block is established and added as a lead-in area before the data block, the organization information block including wrong organization information, and/or an organization information block with a blocking area is established and added as a lead-in area before the data block or (immediately) behind it, d) as an option information for a lead-out area is established and added behind the data block, e) the data stream from step c) or d) is written on a master, and f) with the master obtained in step e) are fabricated a multitude of compact discs. During writing on a master in step e) read-incompatible physical structures can be produced in the blocking area. Of course these structures may extend up into a first audio track and/or CD-ROM track. The previous considerations apply to the method according to the invention in a corresponding manner.

Finally, the invention relates to a software for controlling a system for the fabrication of a master coding for a method according to the invention. Pre-mastering and mastering are controlled in production systems for compact discs by digital programs. Within the framework of the invention, the routines for the establishment of the lead-in and/or process control during the fabrication of a master are modified such that wrong organization information and/or read-incompatible physical structures are brought on the master, and this means, on the fabricated compact discs. A software according to the invention controls, in addition to the conventional mastering processes, in particular the modulation of the data stream signal, and that in dependence of the given position of the blocking area within the data stream.

In the following, the invention will be explained in more detail, based on examples representing one embodiment only.

### EXAMPLE 1

### Fabrication of a Compact Disc Digital Audio Protected from Copying

Digitized pieces of music are lined up as tracks to form the program area representing a data block. Then the organization information block is put together, substantially comprising a table of content (TOC) including the duration of the individual tracks and the format of the tracks. This organization information block is temporarily stored. Then the organization information block is modified with data deviating by 15 s with regard to the duration of the individual tracks, and stored as an organization information block intended for the CD. Then an information block including the blocking area is established, which contains the structure of a CD-ROM information. Finally, a conventional lead-out area is established. Then the so obtained components are lined up in the sequence organization information block, program area, blocking area, and lead-out area for the transfer to a master.

The transfer in a per se known manner, with the exception that during the transfer the LBR (laser beam recorder) is controlled, in addition to the generation of a single “pit” or “land”, over several spiral revolutions (tracks). This has as a consequence that during reading-out of a compact disc fabricated with the master by means of a burner software error messages are produced. Then, using the master in a conventional manner, compact discs are fabricated.

### EXAMPLE 2

### Play-Back of a Compact Disc of Example 1 in a Conventional CD Play-Back Unit

After placing the compact disc into the play-back unit type Kenwood DP4090 and selecting a title, the reader head will move corresponding to the wrong information about the duration of the track to the latter. In doing so, the software of the play-back unit will detect, by the not detected pause in the music, that obviously the beginning of the piece has not properly been addressed. According to the calculation algorithms of the play-back unit, now the immediate neighborhood of the location where the reader head has moved is searched for a section with a pause. The calculation algorithm controls the reader head into a range of approx. ±20 s about the initially selected position. Since the deviation of the actual track from the data with regard to the duration in the first organization information block is only 15 s, the calculation algorithm or the reader head will “catch” the searched pause, and starts play-back of the selected track in a proper way. A user will only detect the effect of the protection from copying, if at all, from that play-back is later by fractions of a second, after selecting the track, compared to a compact disc without the protection system from copying according to the invention. The blocking area is ignored by the play-back unit, since it is not CD-ROM capable. Therefore the blocking area will not be effective.

### EXAMPLE 3

### Trying to Play a Compact Disc According to the Invention on a Computer

A compact disc according to example 1 is inserted into the CD drive of a notebook using the operating system Windows 95. Then the keys Accessories, Multimedia, CD Play-back are selected. After pressing the virtual key “Play” or “Next Title”, the computer starts reproducing the selected track, however not at the beginning thereof, but in the middle of it. Moving to the beginning of the track is not possible. When passing through a selected track, the piece of music will terminate and the next one will start, although there is shown still a time to run of the previous track. Storing a complete piece of music is thus not easily possible.

### EXAMPLE 4

### Trying to Copy a Compact Disc According to the Invention by means of a Burner and Respective Burner Software

To a commercially available computer with the operating system Windows 95 is connected a burner type Yamaha CD-ReWriter 4416S, and the software WinOnCD, version 3.6, is activated. A compact disc to be copied is placed into the burner, as per example 1. Then it is tried, by activation of the option Store CD-DA Sources on Hard Disc of the register Read-out CD-DA, to transfer the contents of the compact disc to the hard disc. After some time the error message CD Not Inserted will appear. Thus the program cannot be executed, and a copy of the compact disc cannot be burnt.

### EXAMPLE 5

### Electronic Circuitry for the Modulation of an Electronic Data Stream Signal

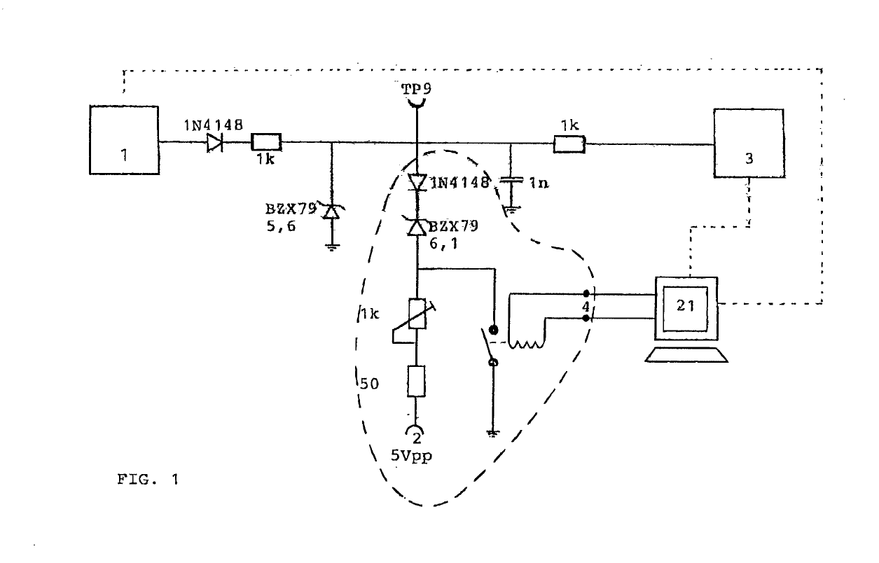

In FIG. 1 is shown a suitable circuitry for the modulation of a data stream signal. It is a circuitry connected to the TP9 of a device Mastering AM200 of the Toolex ODME, Eindhoven, The Netherlands, manufactured in January 2000. The components enclosed by dotted lines are the added electronic components. The other electronic components belong to the mentioned device. Corresponding circuitries can be set up for the device 8″ LBR.

By the acoustics/optics driver (modulator mastering) 1 is provided a signal being adjusted to the speed of the master. Control of driver 1 and master is performed by a computer. The additional circuitry added to the TP9 has the effect that the data stream signal coming from the driver is switched on and off in synchronism with the square wave voltage applied to terminal 2 and is passed for controlling the laser 3. The activation and de-activation of the modulation takes place in this embodiment by the control terminal 4, being in turn connected with the computer for controlling driver and master. The modulation is activated and de-activated at defined times, so that the blocking area is established at the desired position within the sequence of data. This will be explained in more detail in the following examples.

### EXAMPLE 6

### Setting-Up of a Read-Incompatible Blocking Area in the Lead-In Area of an Audio CD

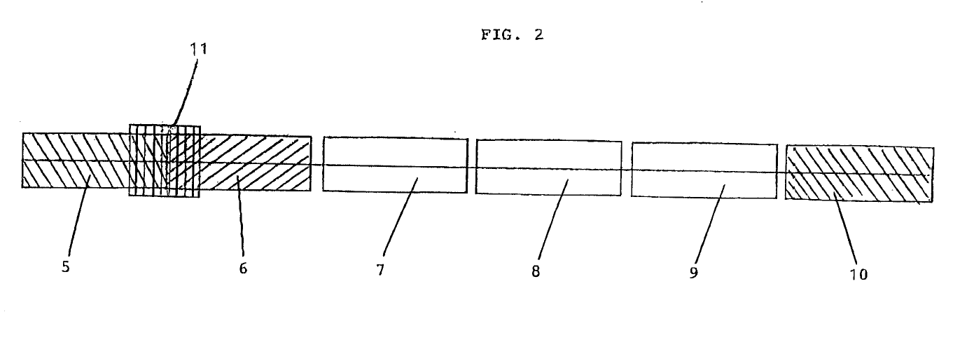

In FIG. 2 is shown a linear development of the data contents of an audio CD as a function of the time in the data stream or as a function of the location on the spiral path of a CD thus fabricated.

First, a lead-in area 5 is shown, fabricated in a conventional way in the audio CD format. The duration of the lead-in area is 02:25 (min:s). Then follows a zero file 6 with a duration of approx. 00:20. Thereafter follow the audio tracks 7, 8, 9 (of course, more than three audio tracks are possible) containing different pieces of music. To the last audio track follows the lead-out area 10. The above times relate to the times for reading the CD at normal speed.

According to the invention, a blocking area 11 is provided, beginning by 00:04 before the end of lead-in area 5 and extending by 00:04 into zero file 6. The blocking area has been fabricated by that during mastering by means of the circuitry of example 5 the modulation has been switched on and off by the control terminal 4 at times, when the data signal streams belonging to the mentioned delay times pass TP9, so to speak.

In the example a signal of 5 Vpp (0 to −5 V) in square-wave shape, with a frequency of 100 kHz and an on-off ratio of 1:6 (1=0 V, 6=−5 V) has been used at terminal 2.

A normal audio player skips the blocking area and begins at the nearest audio track comprising contents. The zero file secures that the first “true” audio track is identified by the player a track 1, and is displayed as such. In contrast thereto, a burner will first try, before reading the audio tracks out, to read complete lead-in area 5 out, which will not have success due to the blocking area, and will lead to an error message or to a termination of the program of the burner.

### EXAMPLE 7

### Setting-Up of a Read-Incompatible Blocking Area in the ROM Lead-In Area of a CD Extra

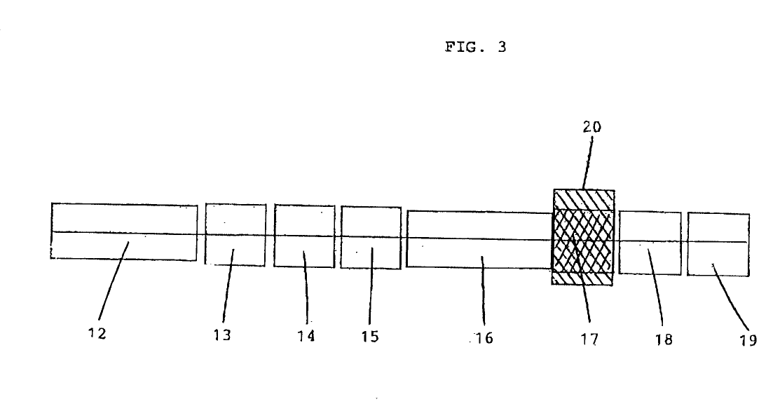

In FIG. 3 is shown a linear development of the data contents of a CD Extra as a function of the time in the data stream or as a function of the location on the spiral path of a CD thus fabricated.

First, a lead-in area 12 is shown, fabricated in a conventional way in the CD Extra format. The duration of lead-in area 12 is 02:25 (min:s). Then follow the audio tracks 13, 14, 15 (of course, more than three audio tracks are possible) containing different pieces of music. To the last audio track follows the lead-out area 16 with a duration of 01:30. Lead-in area 17 for ROM track 18 is 01:00 long. The above times relate to the times for reading the CD at normal speed.

According to the invention, a blocking area 20 is provided, coinciding with the lead-in area 17 for ROM track 18. The blocking area has been fabricated according to example 6 with the following parameters. A signal of 5 Vpp (0 to −5 V) in square-wave shape, with a frequency of 50 kHz and an on-off ratio of 4:1 (4=0 V, 1=−5 V) has been used at terminal 2. Thus, so to speak, lead-in area 17 has been chopped.

This example shows in all generality that CD's, the proper purpose of which is only limited to play-back of audio tracks, can nevertheless be set up for the purpose of protection from copying as a CD Extra. In an analogous manner, other CD formats having further components in addition to the audio components can also be used, the basic concept being that to provide the further components not necessary for the play-back of audio tracks with a blocking area, the further components being detected by a burner, other than a normal audio player, and this burner then trying to read them out. Because of the blocking area in these unnecessary further components, read-out of these areas will not have success, with the consequence of an error message or a termination of the burner program.

1. A compact disc comprising information sections with a data block, in particular audio block and/or CD-ROM, and at least one lead-in area and/or one lead-out area, wherein lead-in area and/or lead/out include a blocking area comprising read-incompatible physical structures.

2. A compact disc according to claim 1, wherein the blocking area is disposed in a lead-in area set up before an audio block.

3. A compact disc according to claim 1 or 2, wherein the blocking area is set up so as to begin 0.1 to 60 s, preferably 1 to 15 s, in particular 2 to 10 s, before the end of the lead-in area.

4. A compact disc to claim 3, wherein the blocking area extends forward into the first track of the audio block, by preferably 0.1 to 60 s, more preferably 1 to 15 s, in particular 2 to 10 s.

5. A compact disc according to claim 4, wherein the first track of the audio block is configured as a zero file and has a length of preferably 1 to 600 s, most preferably 1 to 60 s, in particular 10 to 30 s, measured from the end of the blocking area.

6. A compact disc according to one of claims 1 to 5, in the version CD Extra, wherein at least one blocking area is set up.

7. A compact disc according to claim 6, wherein a blocking area is provided in the lead-in area of the ROM track, and wherein optionally the lead-out area has in addition another blocking area.

8. A compact disc according to one of claims 1 to 7, wherein the blocking area in the lead-in area before the audio bock is produced by modulation of the data stream signal with 10 to 10,000 Hz, preferably 100 to 10,000 Hz, in particular 100 to 1,000 Hz, and/or wherein the blocking area in the lead-in area before the ROM track is produced by modulation of the data stream signal with 1 to 10,000 Hz, preferably 10 to 1,000 Hz, in particular 10 to 100 Hz.

9. A compact disc compact disc comprising information sections in the sequence lead-in area, data block, lead-out area, said lead-in area comprising an organization information block with information about organization properties of the data block, and comprising a section disturbing a copying process, characterized in that the organization information block contains wrong organization information with regard to the immediately following data block and/or contains a non-evaluable blocking area and/or the compact disc contains a second organization information block with a non-evaluable blocking area behind the data block.

10. A compact disc according to claim 9, characterized in that the blocking area contains physical structures being read-incompatible and/or data fragment structures.

11. A compact disc according to claim 9, characterized in that the blocking area has a structure according to organization information and/or CD-ROM data or fragments thereof.

12. A compact disc according to one of claims 1 to 11, characterized in that the read-incompatible physical structures are selected from the group “non-standard pit height, non-standard reflectivity, non-standard track spacing, non-standard edge slope of the pit edges, pit-free track, track with continuous pit, and combinations of such physical structures”.

13. A method for the fabrication of a compact disc according to one of claims 1 to 12, comprising the following steps:
a) a data acquisition takes place, in particular audio and/or ROM,
b) the acquired data are formatted in a data block,
c) an organization information block is established and added as a lead-in area before the data block, the organization information block including wrong organization information, and/or an organization information block with a blocking area is established and added as a lead-in area before the data block or behind it,
d) as an option information for a lead-out area is established and added behind the data block,
e) the data stream from step c) or d) is written on a master, and
f) with the master obtained in step e) are fabricated a multitude of compact discs.

14. A method according to claim 13, wherein within the blocking area during writing on a master in step e) read-incompatible physical structures and/or data fragment structures are produced.

15. A software for controlling a system for the fabrication of masters coding for a method according to claim 13 or 14.
